(19) United States
(12) Patent Application Publication
(10) Pub. No.: US 2014/0156499 A1
(43) Pub. Date: Jun. 5, 2014

(54) BUSINESS METHODS AND SYSTEMS FOR FACILITATING AND ENSURING ONLINE TRANSACTIONS THROUGH LIVE VIDEO AND AUDIO CONFERENCING AND RECORDING

(71) Applicant: Urbano Nieto Cavazos, JR., Corpus Christi, TX (US)

(72) Inventor: Urbano Nieto Cavazos, JR., Corpus Christi, TX (US)

(21) Appl. No.: 13/692,167

(22) Filed: Dec. 3, 2012

(51) Int. Cl. G06Q 20/38

(52) U.S. Cl. CPC G06Q 20/382
USPC 705/38; 705/39; 705/43

(57) ABSTRACT

The present invention relates to a method and a system for facilitating and ensuring online transactions' quality and security, and more particularly to a method and a system for providing an online payment service that uses video and audio recording to facilitate and ensure online transactions. The system comprises a website for customers to interact with a representative from said payment service system and/or view their payment service accounts utilizing a variety of features.

### IN THE UNITED STATES PATENT AND TRADEMARK OFFICE

A non-provisional utility patent application for a:

### BACKGROUND OF THE INVENTION

1. Field of the Invention

The present invention relates to e-commerce business methods and systems, and more particularly to methods and systems for facilitating and ensuring online transactions through live video and audio conferencing and recording.

2. Description of Related Art

For customers who purchase commodities or order service from web-based merchants or service providers or individuals who put on ads to sell new or used items, their most critical concerns are whether the transaction is reliable, whether the payment mechanism is secure, whether the merchant, service provider, or individual is trustworthy, whether the product or description and characterization is fully understood and meets their expectation, whether the conditions and terms of the service are clear and well understood before they order the service.

Customers who buy stuff online sometimes worry whether they made the purchase in a correct manner or selected the right item or shipping method. Sometimes, customers have concerns that there may be corrupt companies that engage in unethical practices. There are also customers who prefer to complete business with a customer representative instead of an automated system. This live operation give customers the feeling that they are talking to the representative face to face when dealing with business, purchasing products, or ordering services.

Therefore, it is advantageous to provide customers a chat room and multi-party conference type of tools to let customer view the representative they are dealing business with, much like the traditional more interpersonal face-to-face communication. It is also advantageous to provide customers an online financial service that records the online transactions by audio and video to ensure the reliability of the transaction. It will also be advantageous to provide customers options for recording the sales and contracting process to ensure that all the transaction is transparent and there is no hidden hole or traps associated with the transaction.

It is also beneficial to the web-based merchants or service provider or individuals who put ads to sell used or new items because there will be less argument or complaints or returning goods due to customer's dissatisfaction.

### SUMMARY OF THE INVENTION

One object of the present invention is to provide an online transaction platform that will provide customers a virtual meeting (chat) room with rich media to meet (view and talk) with representatives from an online payment service provider who help to facilitate and ensure online transactions (payment)'s quality and protects customer's privacy. The online transactions (payments) will be text, video, and audio recorded.

Another object of the present invention is to provide an online transaction platform that will provide customers a virtual meeting (chat) room with rich media to meet with representatives from web-based merchants and service providers (“merchant” hereinafter) so that the customers can view and talk to the representatives in order to get a better understanding of the commodities and services that they are interested in. Once the customer decides what merchandise they would like to buy, they will be redirected to the representatives who deal with payment. The online transactions including sales and payments will be text, video, and audio recorded.

An e-commerce business method and system for facilitating and ensuring online transactions quality and security is disclosed in the present application. Such an online payment service method and system enables payments and money transfer to be made through the internet for online merchants and individuals. One embodiment of said online payment service method and system comprises: payment instruments including establishing a customer's payment service account, processing fund transfer from the customer's payment service account, processing credit card or debit card or wire transfer from bank to pay the merchant for the products or services; audio and video communication with customers; chat box for text entry; multi-party conferencing tool; real time video and audio recording the transaction process; encrypting customer's information; database for storing customer's information, and audio and video transaction record files; a website for customers to view their accounts and perform actions; applications similar to the website but optimized for mobile devices usage utilizing the mobile devices keyboard, microphone, and video camera; video and audio recording capability; and a link to be displayed on the web-based merchant's website or app to redirect customers to the payment service provider's website or app to complete transaction (payment).

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is the disclosed system and method for facilitating and ensuring online transactions whereby the customer can see the online payment service provider's representative while making payments and the online transactions can be video and audio recorded.

FIG. 2 is a flowchart of processes for embodiment 1 of the disclosed system and method.

FIG. 3 is a flowchart of processes for embodiment 2 of the disclosed system and method.

FIG. 4 is a flowchart of processes for embodiment 3 of the disclosed system and method.

### DESCRIPTION OF THE PREFERRED EMBODIMENT

The present invention relates to methods and systems for facilitating and ensuring online transactions through live video and audio conferencing and recording. The methods and systems of the present invention comprise a link for display by an online merchant on the merchant's home page. Once a customer decides to buy a product and make a payment, a customer simply clicks the link which will redirect the customer to the online payment service's website. The payment process will then be audio and video recorded to ensure reliability of online transactions and protect customer's privacy. Other features included in the methods and systems of the present invention are described hereinafter.

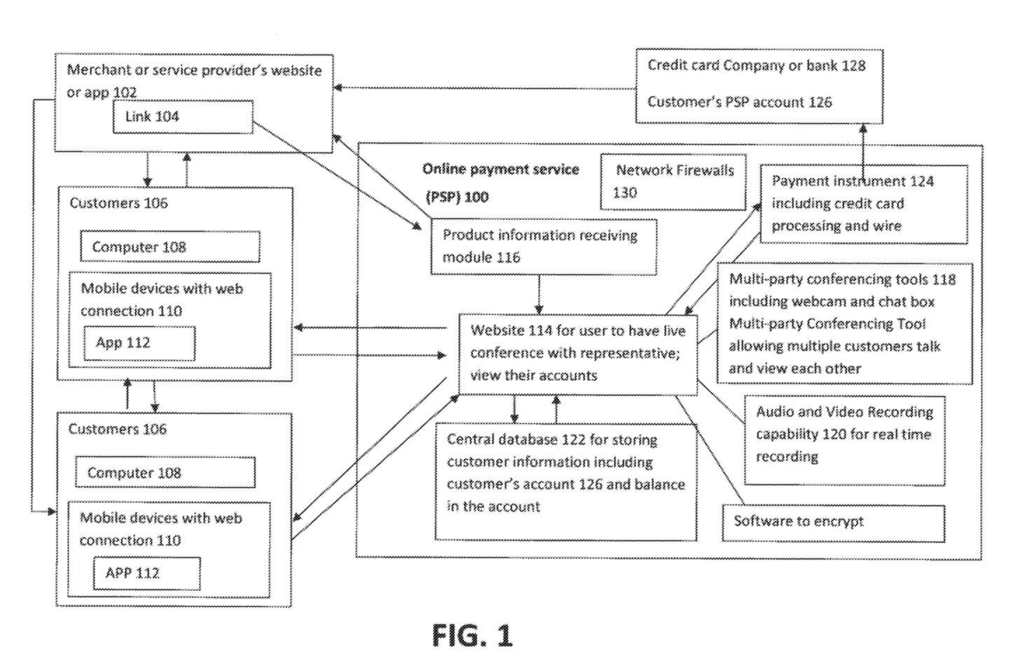

Referring to FIG. 1, there is disclosed an embodiment of the online payment service method and system 100 which performs payment processing for online (or web-based) merchants 102 who subscribe for the payment service 100. The online payment service method and system 100 comprises a link 104 for display by an online merchant 102 on the merchant's home page. Usually, a customer 106 visits the merchant's website 102 using a computer 108 or apps 112 on any mobile devices with web connection 110. The app 112 is similar to the website 102 except it is optimized for mobile devices usage utilizing the mobile devices keyboard, microphone, and video camera.

Once the customer 106 decides to buy a product and make a payment, a customer simply clicks the link 104 which will redirect the customer 106 to the online payment service provider's website 114 in the computer 106 or in the app 112 of the mobile device 110. The online payment service method and system 100 further comprises a module 116 that receives the product or service order information once the link 104 is clicked. The online payment service method and system 100 further has multi-party conferencing tools 118 including web cams which enables the representatives from the online payment service provider 100 to have live conversation with customers. The multi-party conferencing tools 118 allow the customer to invite others (e.g. their parents or guardians) to talk to the representative at the same time. The method and system 100 also comprises video and audio recording system 120 which video and audio records the communication between the representative and customer and the payment process. Once the customer clicks the link and is re-directed to the website 114 they will be able to see a representative appear in the conference (chat) window on the website 114 and is able to carry on a live conversation with the representative who already received product information and price of the product from the online merchant 102 via product information receiving module 116. The representative may repeat the product and price information and a written copy of the product and price will appear in the chat box. The chat box can also be used for text entry and is and may be used by hearing impaired people.

The method and system of the present invention 100 further comprises a central database 122 for storing the customers' information including customer's account, identification, and balance in the account, credit card, and bank information. After the customer provides their identification and account information to the representative, the representative verifies the customer's information. If the information is confirmed, the representative continues to the payment process using the system's payment instrument 124. If the customer is a registered customer who has established an account with the online payment service 100 (“PSP account” hereinafter), the customer can make payment out of the customer's PSP account 126. If there is not enough money in their available funds, the remaining of the money owed can be charged from the confirmed credit card or from the confirmed bank account that the customer has added to their PSP account and have authorized additional funds to be withdrawn from. If the customer does not have a PSP account 126, the representative can help the customer set up his/her PSP account 126 and transfer fund from their bank account or let them pay by credit card or debit card or e-check 128.

The payment instrument 124 can transfer money from customer's PSP account 126 to the online merchant 102 or transfer money from customer's bank account or credit card 128 to the online merchant 102. The entire transaction (payment) process is audio and video recorded. The central database 122 of the method and system of the present invention further stores the text, audio and video transaction record files. A customer can view his/her PSP account 126 on the PSP website 114 or app 112 and manage their PSP account 126 anytime they want.

The online payment service 100 further comprises network firewall 130 to ensure transaction security and customer's privacy. The firewalls can isolate the online payment service provider 100 from external internet accesses and prevent unauthorized internal access to information stored in the database to enhance security within the online payment service provider 100. The data stored will also be encrypted. The customer may allow their information to be stored for faster transaction next time. Rewards would be given to repeated and loyal customers.

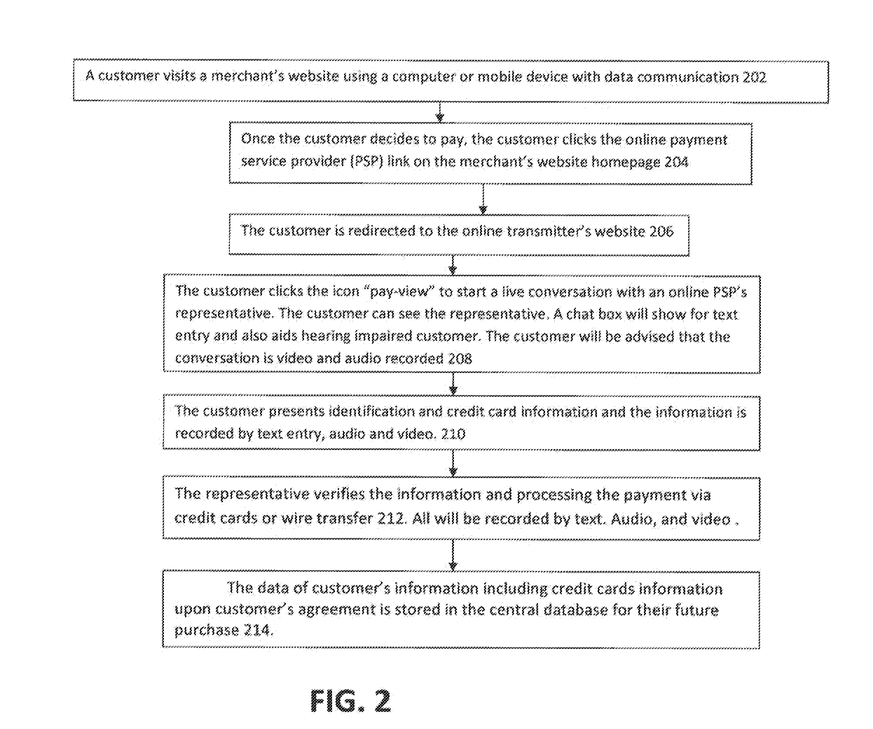

FIG. 2 shows a flow chart 200 illustrating an exemplary procedure in one embodiment. The procedure starts when a customer visits a merchant's or a service provider's website that has a link of the online payment service provider (PSP) of the present invention at the bottom of their homepage 202. When the customer decides to purchase and make payment, the customer clicks on the link and gets redirected to the online payment service provider of the present invention 204-206. At the top page of the online PSP's website, there is a “Pay-view” icon. The customer clicks the icon; there will be representative working for the online payment service provider talking to the customer. Customer can see representative through the representative's web cam. The customer may also choose to enable the representative to see them. The customer will be advised that the conversation and text is video and audio recorded 208 and can choose whether they want it or not. The transaction is video recorded with text and voice recording to ensure the quality of the online transaction. The customer presents identification and credit card information and the information is recorded by audio and video 210. The representative verifies the information and processes the payment via the customer's PSP account or credit cards or transfer from bank 212.

The data of customer's information including credit cards information upon customer's agreement is stored in the central database for their future purchase 214. This is especially good to some customers who do not like to talk to automated system. This live operation gives customers the feeling that they are talking to the representative face to face. The chat box may be used for the customers to enter text or read text for the hearing impaired.

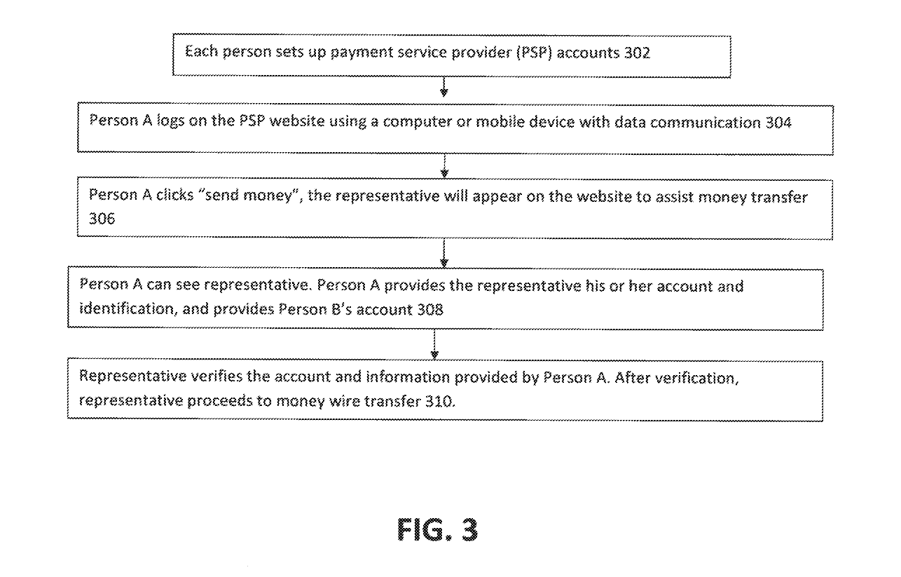

FIG. 3 shows a flow chart 300 illustrating an exemplary procedure in another embodiment. In this embodiment, the e-commerce business method of the present invention provides payment instruments for money wire transfer from one person to another person without going through online merchant's website. This embodiment is a secure transaction for individuals who placed ads to sell items of theirs and small businesses who cannot afford to build or buy the infrastructure to accept credit card payments from buyers in the web-based transaction facility and individuals that would like to buy those items and can not meet in person to pay in cash. In this embodiment, the procedure 300 begins with both parties setting up PSP accounts. Next, after person A decides to buy a product from person B, person A logs on the PSP website and request send money from his or her account to another person's account 304. A representative from PSP will appear on the website and assist money transfer 306. The process will get audio and video recorded. Person A can see the representative live, and provide the representative his or her identification and account as well as person B's account and information (such as an email address that is associated to the account) 308. After the representative verifies person A and person B's information and accounts, he or she can process the money transfer 310. Person B's presence is optional. Person A can invite person B to log onto the PSP website at the same time. The entire money wire transfer process gets text, audio, and video recorded.

The current invention's service further extends to easier methods for the merchant to be payed in person. A first party or third party hardware herein called encrypted transaction card reader may be attached to mobile devices or computers with web connection and current invention's app installed. The amount paid will be deposited into the PSP website.

The gadget will launch the mobile device app or redirect user to the payment service website. User then clicks on the “Pay-view” icon to see the representative (and enable or disable the representative to see the user), talk to the representative, swipe credit card, and live record text, audio, and video record transaction.

The person to person money wire transfer can be utilized between parents and children or friend to friend. It simply functions like a money wire transfer mechanism. So, the parent can transfer money to a college kid for monthly expense.

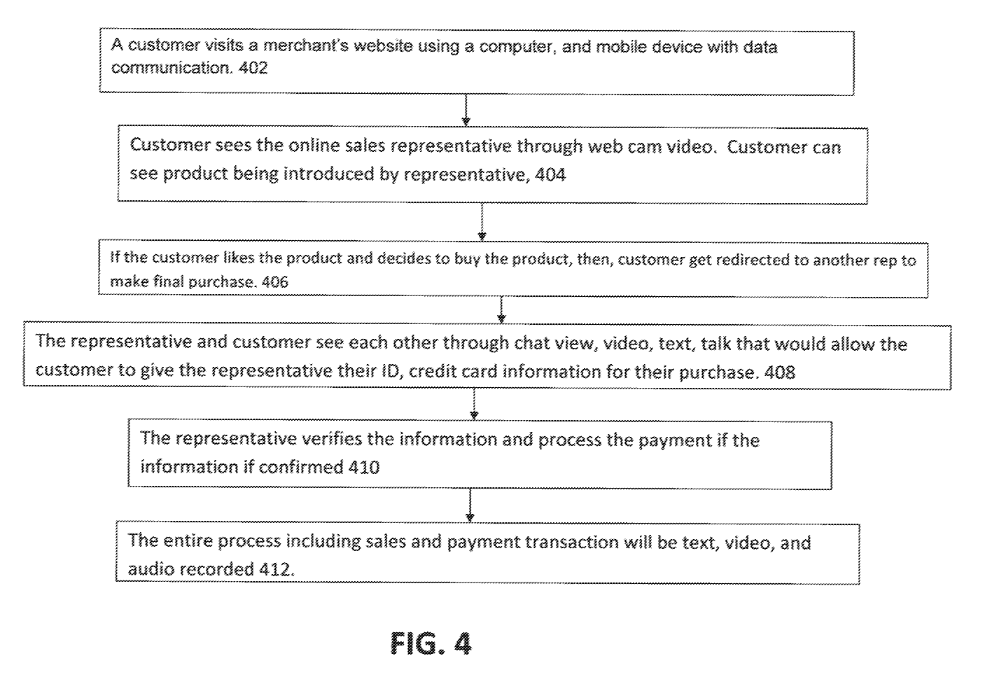

In another embodiment, the e-commerce method of the present invention may be expanded and applied to online marketing, sales, and transactions to facilitate and ensure the online transactions. The business method and system including software can be licensed to other merchants through a license agreement. This business model as illustrated in the flow chart shown in FIG. 4, the flow chart starts when the customer comes to the merchant's website using a computer or mobile device with data communication capability 402. Customer sees the online sales representative through web cam video. Customer can see product being introduced by the sales representative 404. If the customer likes the product and decides to buy the product, the customer gets redirected to another representative to make payment 406. The payment rep and customer see each other through chat view, video, text, talk that would allow the customer to give the representative their ID, credit card information for their purchase 408. The representative verifies the information and process the payment if the information is confirmed 410. The entire process including sales and payment transaction will be video and audio recorded. If the customer agrees, these credit card or bank information can be saved in the central database for future purchases 412.

An embodiment would be licensing the method and system to dealerships. The customer sees a car or truck on the dealership web site. The customer clicks the “pay-view” icon to contact the sales person. A web cam call is then established between the customer and the sales person. The customer can specify the car model, color, price or stock number. The sale person communicates with their boss for the purchase approval of the vehicle that the customer wants to buy. The sales person further collects the information, credit history from the customer. Then, the sales person may make contact with different financial institute to get the best rate for financing the customer's purchase. Once the best rate for the financing of the vehicle is given by the financial institute, then the sales person gets the customer back on the screen by clicking on the icon associated with the customer on the screen. The whole time of the processing on the web cam call with the customer is like a face to face conversation in a car dealership. After the customer completes the vehicle purchase, the vehicle is driven to customer's house or shipped to the customer (extra expense for shipping).

The website and app can display in different languages. A purchase confirmation email may be send to the buyer. The current system and method may have the PSP logo on the sent merchandise to the buyer.

In another embodiment, video audio recording software and hardware of the present invention can be integrated with ATM transaction.

The current system and method may be extended to selling and shipping merchandises directly. As shown in FIG. 3, the multi-party conferencing tool that offered by the business method of the present invention allows multi users to view each other when purchasing items. This tool is especially useful for college students who want to buy something or want a money transfer into their account. By clicking on the tab that says add additional viewers, the program will allow multiple people to connect and see each other to make the transaction.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An online payment service method of facilitating and ensuring online transactions through the internet for merchants and individuals, the method comprising:
providing a website for computer with data connection for customers to interact with a representative from said payment service system and/or view their payment service accounts;
providing an application (app) optimized for mobile devices with web connection for customers to interact with a representative from said payment service system and/or view their payment service accounts that utilizes the mobile devices keyboard, microphone, and video camera;
providing a web-based merchant a payment service website link that is displayed on the merchant's website or app and can redirect a customer to said payment service website or app upon selection of the link;
providing multi-party conferencing tools including audio and video communication module and chat box for text entry for allowing interaction between a customer and a representative from said payment service;
providing a real time video and audio recording module for video and audio recording the transaction process;
providing a receiving module for receiving the product, charge, customer information;
providing a database for storing the customer's information;
providing network firewall and encrypting customer's information to ensure transaction security and customer's privacy; and
a payment module for processing payment and/or money transfer via customer's payment service account, credit cards, debit cards, and/or bank;
wherein the transaction process is video and audio recorded.

2. The method of claim 1 further comprising providing an encrypted transaction card reader which can be attached to computers or the mobile devices with web connection and said payment service app installed for online transaction.

3. The method of claim 1 wherein the payment module enables the representative electronically transfer fund from the customer's payment service account to the online merchant that sells the product or service to the customer.

4. The method of claim 1 wherein the payment module enables the representative to electronically transfer fund from a customer A's payment service account to a customer B's payment service account who is an individual or a non web-based small business entity who sells the product or service to the customer A.

5. The method of claim 1 wherein the payment module enables the representative to electronically transfer fund from a parent's payment service account to a child's payment service account.

6. The method of claim 1 further comprising obtaining additional information of the customer including credit check.

7. The method of claim 1 further comprising obtaining financing information from financial institutes in order to give customer best rate for financing.

8. The method of claim 1 further comprising providing delivering the products to the customer for the web-based merchants after the customer's payment is processed and completed.

9. The method of claim 1 further comprising providing software and hardware that can be integrated with ATM to video and audio record the transaction.

10. An online payment service system for facilitating and ensuring online transactions for merchants and individuals by video and audio recording the transaction process, the system comprising: a website for customers to interact with a representative from said payment service system and/or view their payment service accounts; an applications (app) similar to the website for mobile devices for customers to interact with a representative from said payment service system and/or view their accounts that uses the mobile devices keyboard, microphone, and video camera; multi-party conferencing tools including audio and video communication module and chat box for text entry; a real time video and audio recording module for video and audio recording the transaction process; a database for storing customer's information; encrypting customer's information; a link that is displayed on a merchant's website or app and redirects a customer to said payment service system's website or app upon selection of the link; a receiving module for receiving information regarding a product and payment; a network firewall to isolate the online payment service from external internet accesses and prevent unauthorized internal access to information stored in the database; and a payment module for processing payment and/or money transfer via customer's payment service account, credit cards, debit cards, and/or bank.

11. The system of claim 10, wherein the system can be integrated to an ATM.

12. The system of claim 10, wherein the multi-party conferencing tool can be used for family members and friends that participate in the payment process simultaneously so that it allows parents or guardian to take part in the purchasing/payment process.

13. The system of claim 10 further comprising compatible hardware, more specifically a gadget for credit card processing that can attach to mobile devices.

14. The system of claim 10 further comprising a product delivery module for managing product shipment to the customer after the customer's payment is processed and completed.
